(19) United States
(12) Patent Application Publication
(10) Pub. No.: US 2026/0065305 A1
(43) Pub. Date: Mar. 5, 2026

(54) ARTIFICIALLY-INTELLIGENT SYNTHETIC DATA PERSONAS BASED ON CERTIFIED HUMAN INTELLIGENCE

(71) Applicant: CloudResearch LLC, Flushing, NY (US)

(72) Inventors: Jonathan Robinson, Flushing, NY (US); Leonid Litman, Bronx, NY (US); Reuben Paris, Flushing, NY (US)

(21) Appl. No.: 19/384,110

(22) Filed: Nov. 10, 2025

Related U.S. Application Data
(63) Continuation-in-part of application No. 19/218,438, filed on May 26, 2025.
Application No. 19/218,438 is a continuation of application No. 18/934,448, filed on Nov. 1, 2024, now Pat. No. 12,314,969.
Application No. 18/934,448 is a continuation-in-part of application No. 18/766,833, filed on Jul. 9, 2024, now Pat. No. 12,243,066.

(51) Int. Cl. G06Q 30/0203; G06F 40/186; G06F 40/58

(52) U.S. Cl. CPC G06Q 30/0203; G06F 40/186; G06F 40/58

(57) ABSTRACT

A method for generating artificially-intelligent, synthetic responses to a natural language conversational survey is provided. Methods create a synthetic persona that reflects an authentic human. Methods store the synthetic persona as vectors within a vector database. Methods initiate a survey. Methods select the synthetic persona from the vector database. The selection is based on a correspondence between data points input by the researcher and vectors included in the synthetic persona. Methods initiate the survey with the selected synthetic persona as a participant. Methods generate a first question for the survey. Methods augment, at the vector database, the first question with vectors that correspond to data points relevant to the first question. Methods transmit the augmented first question to a large language model. Methods receive a response to the augmented first question. Methods process the response at the survey system. Methods enable the researcher to analyze the survey.

### CROSS-REFERENCE TO RELATED APPLICATIONS

This application is a continuation-in-part of U.S. patent application Ser. No. 19/218,438 filed on May 26, 2025 and entitled “NATURAL LANGUAGE SURVEY SYSTEM,” which is a continuation of U.S. patent application Ser. No. 18/934,448 filed on Nov. 1, 2024 and entitled “NATURAL LANGUAGE SURVEY SYSTEM,” now U.S. Pat. No. 12,314,969, which is a continuation-in-part of U.S. patent application Ser. No. 18/766,833 filed on Jul. 9, 2024, and entitled “NATURAL LANGUAGE SURVEY SYSTEM” now U.S. Pat. No. 12,243,066, all of which are hereby incorporated by reference herein in their entireties.

### FIELD OF TECHNOLOGY

Aspects of the disclosure relate to generation of synthetic data.

### BACKGROUND OF THE DISCLOSURE

Researchers conducting research typically sample an array of participants to conduct a survey. Alternatively, researchers sample an array of participants to perform any suitable type of research project. Many times, the researchers require participants with a specific set of criteria. However, the selected participants may be unable to participate in the survey or research project for a variety of reasons.

As such, it would be desirable to create synthetic personas. Such synthetic personas may be able to participate in surveys or research projects in lieu of authentic people.

It would be further desirable for such synthetic personas to be mapped to authentic humans. As such, such synthetic personas may participate in the survey or research projects in the same way as the corresponding authentic humans would participate.

It would be further desirable for surveys or research projects to provide genuine, real-world, results without directly involving human participants.

### SUMMARY OF THE DISCLOSURE

Aspects of the disclosure relate to generating synthetic responses to survey questions. In order to generate synthetic responses that map on a human response, a synthetic persona may be generated. The synthetic persona may be mapped on an authentic human. Significantly, the synthetic persona may correspond to features of the authentic human. Instead of entailing the authentic human to participate in the survey or other research project, the synthetic persona may be utilized.

The synthetic persona may be electronically created by the survey system. The survey system may communicate with a computing device. The computing device may be a mobile device, personal computer (“PC”) or any other suitable device. The computing device may be operated by an authentic human. The authentic human may correspond to the synthetic persona. The synthetic persona may be based, in part, or in whole, on the electronic communications between the survey system and the computing device. The synthetic persona may be based, in part, or entirely, on the communications between the human and the computing device. The electronic communications between the survey system and the computing device may be based, in part, or entirely, on the communications between the human and the computing device.

The survey system may transmit an electronic data request to the computing device. The electronic data request may request data from the authentic human. The electronic data request may be transmitted via the computing device. Examples of requested data may include demographic data (gender, residential address, age, race, etc.), occupational data and personalized data (travel plans, feelings, association to various cultures, writing sample, voice sample, opinions, style, attitude).

Other examples of requested data may include social media profile data. The social media profile data may identify social media profiles associated with the authentic human. The social media profile data may include social media profile access data. Social media profile access data may be data used to access the social media profiles. Examples of such data may include, for example, usernames and passwords that provide access to the social media profiles.

Other examples of requested data may include blog profile data. The blog profile data may identify blog profiles associated with the authentic human. The blog profile data may include blog profile access data. Blog profile access data may include data used to access the blog profiles. Examples of such blog profile access data may include, for example, usernames and passwords that provide access the blog profiles.

Other examples of requested data may include email account data. The email account data may identify an email account and/or email address associated with the authentic human. The email account data may include email account access data. Email account access data may include data used to access the email account. Email account access data may include, for example, usernames and passwords that provide access to the email account.

The survey system may create a synthetic persona based on the received data. In some embodiments, the survey system may utilize the received data to crawl and retrieve, from a network, other data associated with the authentic human. The network may include an entity network, the Internet and/or any other suitable network. Other data may include, for example, associations, likes, dislikes and personality traits. The other data may be inferred from the social media profiles, blog profiles and/or email accounts. Other data may also include, for example, style, emotions, grammar and word choice. Such other data may also be inferred from the social media profiles, blog profiles and/or email accounts.

An example of the transition of data into a synthetic persona may be shown below. Table A shows illustrative received data. Table B shows an illustrative synthetic persona based on the illustrative received data. Table C shows an illustrative enhanced synthetic persona, in which the received data was input into an LLM with an instruction to enhance the synthetic persona and fill-in the data gaps.

TABLE A
Illustrative Received Data.
Demographics:

| | |
|---|---|
| Age: | 28 |
| Race: | White |
| Gender: | Male |

Also, the survey system may input historical survey data into the synthetic persona. The historical survey data may include previously conducted surveys or research projects that involved the authentic human. The historical survey data may also include data inferred from the previously conducted surveys or research projects. The historical survey data may include, for example, previous responses, grammar, style, word choice and emotions.

The data received, crawled and/or retrieved may be used to generate a synthetic persona. At times, the data received, crawled and/or retrieved may be input into a large language model (“LLM”). The LLM may process the data and generate a persona. The persona may be a synthetic persona. The synthetic persona may be characterized as operating alongside the authentic human. The synthetic persona may also be referred to as replicating, or providing an operable reflection of, the authentic human.

At times, the LLM may fill in additional data into the synthetic persona. As such, the synthetic persona may be an enhanced synthetic persona. An enhanced synthetic persona may be a synthetic persona in which the LLM enhanced the synthetic persona. Such enhancement may include adding additional data to the synthetic persona. The additional data may be data aside from what was received, crawled and/or retrieved.

In certain embodiments, the LLM may generate data which may override received, retrieved or crawled data. Other times, the received, retrieved or crawled data may override data generated by the LLM. Whether the LLM generated data overrides the received data and/or if the received data overrides the LLM generated data may be triggered by an override selection. The override may determine which data (either the LLM generated data or the received, retrieved or crawled data) is assigned a higher level of importance. Data assigned to a higher level of importance may supersede other data, and therefore, may be used to answer received questions within a survey.

The override selection may be a customizable setting. The customizable setting may be electronically selected by a researcher conducting an electronic survey or research project. The customizable setting may be electronically selected by any other suitable selector. The customizable setting may have a system setting. The system setting may be preferably a default system setting. As such, when the customizable setting has not been positively selected, the customizable setting may be assigned to the default setting. The default setting may be the LLM generated data overriding the received, retrieved or crawled data. The default setting may be the received, retrieved or crawled data overriding the LLM generated data. Alternatively, the default setting may alternate between the LLM generated data or the received, retrieved or crawled data based on a predetermined set of parameters.

The synthetic persona may map on qualities of the authentic human. The synthetic persona may be able to conduct surveys and/or research experiments in lieu of the authentic human. It should be noted that the quality of the data produced by leveraging the synthetic persona to conduct an electronic survey may be the same as, or substantially similar to, the quality of data produced by conducting an electronic survey with the corresponding authentic human.

In certain embodiments, the survey system may identify a minimum threshold of data to form an operative synthetic persona. As such, if an authentic human, via a user device and/or via any other suitable method, provides less than a minimum threshold of data or the survey system is unable to retrieve accurate data from a network regarding the authentic human, the survey system may fail to generate the synthetic persona. This may be because the data, provided by the authentic human via the user device and/or via any other suitable method, is insufficient to complete the minimum threshold of data requirement. This may also be because the survey system is unable to retrieve accurate data from a network regarding the authentic human.

At times, the minimum threshold of data requirement may be fulfilled by the data received, retrieved and/or crawled. Other times, the minimum threshold of data requirement may not be fulfilled by the data received, retrieved and/or crawled. Received data may be understood to be data received from the authentic human. Retrieved data may be understood to mean data retrieved from one or more data sources. Crawled data may be understood to mean data obtained by the survey system crawling a network to locate data pertaining to the authentic human. It should be noted that the minimum threshold of data requirement may not be fulfilled by data generated by the LLM. Accordingly, data generated by the LLM may be insufficient to satisfy the minimum threshold of data requirement.

In some embodiments, the synthetic personas may operate within a survey system and/or research environment. As such, the synthetic personas may be selected as participants in a natural language survey. The natural language survey may be electronically conducted with the synthetic personas in the same manner as a natural language survey may be electronically conducted with an authentic human via a natural language survey system. As such, the natural language conversation between the synthetic persona(s) and the natural language survey system may be made available to a researcher for review and analysis.

In certain embodiments, the LLM may select, and/or enable a researcher to select synthetic personas applicable to a survey. The LLM may select synthetic personas based on data provided by the researcher. For example, if a researcher is conducting a survey about airline pilots, the LLM may select synthetic personas that are airline pilots, have flown aircrafts and/or plan on flying aircrafts. In another example, if a researcher is conducting a survey regarding ice cream eaters, the LLM may select synthetic personas that have recently eaten ice cream and/or are qualified to eat ice cream (e.g., non-diabetic).

The selection of the synthetic personas by the LLM may be a random selection. In some embodiments, the researcher may instruct the LLM to select a predetermined number of appropriate participants. In certain embodiments, the selection of the synthetic personas may be executed by the researcher. As such, the researcher may view a selectable electronic display of all available synthetic personas and/or available selectable personas relevant to the survey. The researcher may, in some embodiments, select each synthetic persona that the researcher would like to include in the survey.

At times, electronic execution of the natural language survey may be operated by one or more LLMs. The LLMs may generate questions and conduct a natural language survey with participants. The questions and electronic communications generated by the LLM during execution of the natural language survey may be based on electronic input provided by a researcher. LLMs may also execute one or more electronic reviews and analyses of a natural language survey conducted with one or more participants. As such, the prompts provided to the LLMs conducting the electronic survey may include the synthetic persona data. Furthermore, the LLMs conducting the natural language electronic survey may understand the personality of the synthetic persona. The LLMs may tailor the questions and/or communications to the synthetic persona based on the LLMs understanding of the personality of the synthetic persona.

It should be noted that an order of questions may be a factor when conducting a natural language survey. As such, the survey system and/or associated LLMs may order the questions and/or communications in a suitable manner. The suitable manner may be used to obtain additional and/or deeper data from the participants.

Examples of snippets of natural language conversations that may be electronically conducted between the synthetic persona and the natural language survey system may be included in Table D. Examples of snippets of review and analysis generated by the natural language survey system in response to a natural language survey electronically conducted between a synthetic persona and a natural language survey system are included in Table E.

TABLE D
Illustrative Snippets of Natural Language Conversations
Electronically Conducted between a Synthetic Persona
and a Natural Language Survey System.

Natural Language Survey System: Do you believe in
animal control, and why?
Natural Language Survey System: Have you changed
your opinion regarding animal control in the past
five years?
Synthetic Persona: I have become more concerned
about the quality of animal life in the past three
years.
Natural Language Survey System: What instigated
that change?
Synthetic Persona: When I became a maintenance
person in a zoo three years ago and witnessed
human cruelty towards animals, my view of animal
control shifted.

TABLE E
Illustrative Snippets of Review and Analysis Generated by
the Natural Language Survey System in Response to a Natural
Language Survey Electronically Conducted between a Synthetic
Persona and a Natural Language Survey System.

On a scale of 1-5, how much does the participant
believe in animal control?
Give reasons why the participant feels strongly
about animal control?
Has the participant changed opinions regarding
animal control and why?

It should be noted that authentic humans, their opinions, their personalities and their data evolve over time. As such, if an authentic human is mapped to a synthetic persona, the synthetic persona may require updates. The updates may correspond to changes to life data of the authentic human. The updates to the synthetic persona may be obtained by continually, continuously and/or periodically crawling profiles associated with the authentic human associated. Such profiles may include, for example, the social media profiles, blog profiles and/or email accounts. The updates may also be obtained by the system requesting updated data from the human. The system may request the updated data by communicating with the human via the user device. The updates may also be obtained by the system conducting a natural language survey with the human. The natural language survey may be conducted via communications between the system and the user device. The updates to the synthetic persona may also be obtained by any other suitable method.

It should be noted that, in the event that updates to the synthetic persona are not received and/or are unable to be retrieved, the synthetic persona may be retired. A retrieved synthetic persona may be labeled inactive. A synthetic persona which is labeled inactive may be unable to be selected for use in a survey.

The system may include a plurality of such AI/LLM-developed and/or enhanced subjects/personas. The subjects/personas may participate in surveys. The surveys may include actual surveys and/or sample surveys. The AI/LLM-developed and/or enhanced subjects/personas may take sample surveys to test the functionality of a survey. The AI/LLM-developed and/or enhanced subjects/personas may take actual surveys as participants.

These subjects/personas may be pre-built to have a specific set of demographics and personalities that can be used to test elements of the natural language survey. The personalities may be designed to represent authentic humans, standard subjects and/or difficult subjects. Standard subjects may provide expected answers to question stems. Difficult subjects may purposely give challenging or incorrect answers to question stems.

The system may enable a researcher to create an AI/LLM-developed and/or enhanced subjects/personas. The researcher may use natural language to describe user archetypes. The created AI/LLM-developed and/or enhanced subjects/personas can then take the survey to deliver results, such as actual results and/or test results. The actual results and/or test results may be reviewable by the researcher. The researcher may be able to modify the survey based on the delivered results, which may include, for actual results, sample surveys and/or test results.

The AI/LLM-developed and/or enhanced subjects/personas may stress-test surveys prior to exposure to live subjects or other AI/LLM-developed and/or enhanced subjects/personas. The AI/LLM-developed and/or enhanced subjects/personas may be used to test elements of the natural language survey.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIGS. 4A and 4B show illustrative diagrams in accordance with principles of the disclosure;

FIG. 5 shows yet another illustrative diagram in accordance with principles of the disclosure;

FIG. 6 shows still another illustrative diagram in accordance with principles of the disclosure;

FIG. 7 shows yet another illustrative diagram in accordance with principles of the disclosure;

FIGS. 8A and 8B show illustrative diagrams in accordance with principles of the disclosure;

FIG. 9 shows yet another illustrative diagram in accordance with principles of the disclosure; and

FIG. 10 shows an illustrative flow diagram in accordance with principles of the disclosure.

### DETAILED DESCRIPTION OF THE DISCLOSURE

Apparatus, systems and methods for generating synthetic responses to survey questions may be provided. Such a system may include a database, a large language model (“LLM”) and a hardware processor. Such a system may be operable to electronically communicate with researchers generating an electronic survey. Such a system may also be operable to electronically communicate with participants electronically participating in an electronic survey. Such a system may also be operable to electronically communicate with researchers analyzing the results of an electronically executed survey.

Synthetic personas may electronically participate in an electronic survey. At times, the electronic participants may participate in the survey in addition to live participants. Also, at times, electronic participants may participate in the survey in lieu of live participants.

The database may be operable to store data. The database may be operable to store data collections. The data collections may correspond to a human profile. The data collections may operate as a synthetic persona. The human profile may include demographic data, emotions, grammar, style and word choice. The human profile may also include responses to questions within historical surveys. The human profile may include any other suitable data.

The data collection may include a writing style, a talking style, a use of a grammar, a demographics set, one or more social media profiles and/or one or more blog articles. The data collection may also include data relating to how the user linked to the data collection responded to standard surveys and/or data relating to how the user device linked to the data collection responded to natural language surveys. The data collection may include any other suitable data.

The processor may be in communication with the database. The processor may receive a request to generate a synthetic persona. In response to the request and/or independently (i.e., not in response to a request), the processor may receive, retrieve, crawl and/or generate real-time updates to the human profile. The real-time updates may include demographic data, emotions, grammar, style and word choice. The real-time updates may also include responses to questions within historical surveys. The real-time updates may also include any other suitable data.

The receipt, retrieval, crawl and/or generation may be executed by the processor. In certain embodiments, the processor may receive data from the authentic human. The data may be received from a user device. The user device may be associated with the authentic human. The user device may map to the human profile associated with the data collection. The data may be received at the processor via a communication link between the processor and the user device. In some embodiments, the processor may retrieve data from one or more data sources. In certain embodiments, the processor may crawl one or more networks for data pertaining to the synthetic persona. The processor may store the real-time updates as human profile data in the data collection stored in the database.

In certain embodiments, the processor may augment the data collection with a filler set of human profile data output from the LLM. The LLM may be in communication with the hardware processor. The data output from the LLM may be output in response to receipt at the LLM of a data output instruction. The data output instruction may be referred to as a prompt. The prompt may include the human profile data and/or the data collection. The prompt may include an instruction to output the filler set of human profile data that fills in data gaps in the human profile data and/or data collection.

The processor may receive a request to initiate an electronic survey. The request may include a plurality of data parameters setting forth a class of requested participants of the survey. The data parameters may include boundaries that limit the data class. The processor may iterate through the plurality of data collections to retrieve a subset of data collections that fits within the plurality of data boundaries.

The processor may execute an electronic survey. One or more participants in the electronic survey may be set to the subset of data collections. The electronic survey may be a simulated natural language conversation between a persona embodied by a data collection (included in the subset) and an artificial intelligence (“AI”) large language model-based conversational assistant.

The processor may store the simulated natural language conversation in a location within the database. The location may be linked to a storage location that stores the data collection. The stored simulated natural language conversations may be made electronically available to the researcher initiating the survey. As such, the researcher may be able to analyze and process results of the survey. It should be noted that, upon completion of a question within the survey, or upon completion of a completed survey, the natural language conversation may be considered a real-time update and may be used to update the data collection.

The received, retrieved and/or crawled data may be considered a raw data set. The raw data set may be used to fine-tune an existing artificial intelligence (“AI”) model, such as for example, a large language model (“LLM”) and/or a small language model. The AI model may correspond to a synthetic persona. The raw data set may be used to train a new AI model, such as, for example, an LLM and/or a small language model.

The raw data set may be stored for use with retrieval-augmented generation (“RAG”). RAG may be an AI framework that may enhance the accuracy and relevance of LLMs by incorporating information from external knowledge sources. Instead of relying solely on the LLM's pre-trained data, RAG enables the model to retrieve specific, relevant information from a designated knowledge base before generating a response. This approach may minimize hallucination, where the LLM generates information that is off-target, and allows for more up-to-date and contextually relevant answers.

RAG may include three steps: a retrieval step, an augmentation step and a generation step. A query may be received at an LLM operating in conjunction with a RAG system. The query may have been transmitted from a user device. During the retrieval step, the RAG system initially executes a search, such as, for example, a vector similarity search and/or semantic-based search, or any other suitable search, on a knowledge base for relevant information. The knowledge base may include documents, databases, or other data sources. The knowledge base may be specific to a discipline. The knowledge base may be specific to the enterprise operating the LLM. The knowledge base may be a vector database. The search may include a vector similarity search and/or semantic-based search. Such searches may identify content based on meaning rather than purely keyword matching.

The augmentation step may include incorporating the retrieved information into the original user query. As such, the original user query may be augmented with additional context.

The generation step may include passing or electronically transmitting the augmented query to the LLM. The LLM may generate a response based on both its pre-trained knowledge and the augmented additional context.

RAG may improve LLM processing by improving accuracy and reliability of the LLM. Specifically, by grounding an LLM-based response in external knowledge sources, the likelihood of generating inaccurate or hallucinations is mitigated. RAG also enables LLMs to access and utilize information that may not be included in their initial training data, making the responses more appropriate for time sensitive questions. RAG also enables LLMs to consider a wider range of contextual information, which may result in the LLM delivering nuanced and comprehensive responses. RAG may be a method to improve LLM performance in a less resource consumptive manner than retraining or fine-tuning the entire model. RAG may enable entities to control the LLM-based responses by tailoring the knowledge base to their specific discipline.

As explained above, RAG may be used in conjunction with a vector database. RAG may combine retrieval of relevant data and generate additional data using an AI model. RAG may utilize a vector database to access the most relevant data based on sematic similarity. The vector database may be considered a more primitive machine learning system than an LLM. However, the vector database may be more directed and therefore more easily manipulated than an LLM or AI system. The vector database may retrieve the most relevant data points to provide to the LLM or AI system.

The raw data set may include for example 1000 data points. During the processing, RAG may communicate 50 data points to the LLM. As such, RAG in conjunction with the vector database, may focus the LLM to obtain accurate results for the query, as described herein.

Processing the raw data set via RAG may include a data ingestion step, a query execution step and/or a response generation step. During the data ingestion step, the data may split into chunks. Each chunk may be embedded in a vector. The vectors may be stored in a vector database. As such, the synthetic personas may be stored within the vector database as one or more vectors.

The query execution step may involve embedding the query into a vector. The vector database may retrieve the most relevant document chunks/vectors based on vector similarity. The response generation step may involve transmitting the retrieved chunks/vectors to an AI model, such as, for example, an LLM.

The retrieved chunks/vectors may provide the AI model with context to the query. As such, the chunks/vectors may be considered an initialization prompt. The query and/or the vector corresponding to the query may also be transmitted to the AI model. At times, the query and/or the vector corresponding to the query may be included in the prompt. The AI model may generate a response based on the one or more inputs, such as, for example, the prompt. The response generated by the AI model may be grounded in the data provided within the initialization prompt.

One or more of the plurality of data collections may be temporarily retired upon occurrence and/or detection of a predetermined trigger. The predetermined trigger may include termination of a communication link between the human profile and the user device. The predetermined trigger may include lapse of a predetermined amount of time (from initiation of the data collection or from receipt of a real-time update). The predetermined trigger may include failure to complete, by the user, a predetermined number of questions. The predetermined trigger may include failure to provide, by the user, a predetermined amount of data. The temporarily retired data collection may be labeled, flagged or tagged as inactive and unable to be included in the subset. The temporarily retired data collection may be moved to a second memory location within the database. The processor may prevent data collections located within second memory location from being included into the subset. Data input from the user device, receipt of a real-time update, retrieval or a real-time update and/or any other suitable electronic indication of an updated communication may reinstate the temporarily retired data collection as active. Reinstated data collections may be moved from the second memory location to the original memory location or a second memory location.

At times, the hardware processor may assign a level of confidence to a response to a question within the electronic survey The level of confidence may be based on whether a data element included in the data collection used to respond to the first question was augmented data from the large language model. When the data element included in the data collection used to respond to the first question was augmented from the large language model, the response may be assigned a lower confidence score than when the data element is included in the data collection that was input via the communication link.

The LLM may peruse the database to auto-identify and auto-generate functional dependencies between data elements included in the data collections. As such, the LLM may retrieve data points and associate certain data points together. The LLM may define semantic relationships between data points. Examples of semantic relationships may be that the terms king and man may be closely related.

A method for generating artificially-intelligent, synthetic responses to a natural language conversational survey may include electronically receiving, by a hardware processor, a data set corresponding to a human profile.

The data set corresponding to the human profile may include raw demographic data and raw responses to historical survey questions. The raw responses may include raw emotional data, raw text responses, raw style data, raw grammar data and raw word choice.

In some embodiments, prior to electronically converting the human profile data collection, the method may include electronically augmenting the data set. The data set may be electronically augmented by communicating the data set to a large language model (“LLM”), receiving, from the LLM, filler data and inputting the filler data into the human profile data collection.

In such an embodiment, the method may include assigning a level of confidence for a response to a first question within the electronic survey based on whether a data element included in the human profile data collection used to respond to the first question was augmented from the LLM. The data element included in the human profile data collection used to respond to the first question was augmented data from the LLM, assigning a lower confidence level than when the information included in the data collection was electronically received or electronically crawled.

The method may include electronically converting the data set to a human profile data collection. The human profile data collection may include synthetic demographic data generated based on the raw demographic data. The human profile data collection may include synthetic responses to historical survey questions based on the raw responses to historical survey questions. The synthetic responses may include synthetic emotional data based on the raw emotional data, synthetic text response data based on the raw text response data, synthetic style data based on the raw style data, synthetic grammar data based on the raw grammar data and synthetic word choice data based on the raw word choice data.

The human profile data collection may include a writing style. The human profile data collection may include a talking style. The human profile data collection may include a use of a grammar set. The human profile data collection may include a demographic set. The human profile data collection may include one or more social media profiles. The human profile data collection may include one or more blog articles. The human profile data collection may include a data set relating to how a user device linked to the human profile data collection responded to standard surveys. The human profile data collection may include a data set relating to how a user device linked to the data collection responded to natural language conversational surveys.

It should be noted that one or more of the plurality of human profile data collections are temporarily retired upon detection of a predetermined trigger. The predetermined trigger may include termination of a communication link between the human profile data collection and a user device. Termination of a communication link between the human profile data collection and a user device may be understood to mean that a periodic data stream flowing from the user device to the human profile data collection has been terminated. The predetermined trigger may include lapse of a predetermined amount of time from instantiation of the human profile data collection. The predetermined trigger may include a failure to electronically complete, by a user associated with the human profile data collection, a predetermined number of questions. The predetermined trigger may include a failure to electronically transmit, by the user, a predetermined amount of data.

In an embodiment where one or more of the plurality of human profile data collections are temporarily retired upon detection of a predetermined trigger, the method may include electronically labeling, within the database, the one or more temporarily retired human profile data collections inactive. In such embodiments, the method may also include electronically preventing the one or more human profile data collections labeled inactive from being included in the subset.

In such an embodiment, the method may further include receiving input data from a user device associated with a temporarily retired human profile data collection included in the one or more temporarily retired human profile data. The method may include electronically labeling the temporarily retired human profile data as active. The method may include re-enabling the active human profile data collection from being included in the subset.

The method may include electronically crawling a network for real-time updates. The electronic crawling may be executed by a hardware processor. The network for real-time updates may be updates to the human profile data collection. The human profile data collection may be stored in the database. The database may be in electronic communication with the hardware processor. The electronic crawling may be executed periodically.

The method may include electronically retrieving, by the hardware processor, the real-time updates.

The method may include electronically storing, by the hardware processor, the real-time updates as human profile data. The real-time updates may be stored in the human profile data collection stored in the database.

The method may include receiving an electronic request. The receiving may be executed by the hardware processor. The electronic request may initiate an electronic survey. The electronic request may include a plurality of data boundaries. The plurality of data boundaries may set forth a class of requested participants of the electronic survey.

The method may include iterating through a plurality of human profile data collections stored at the database, the plurality of human profile data collections including the human profile data collection. The iterating may be executed by the hardware processor. The method may further retrieve a subset of human profile data collections that fit within the plurality of data boundaries.

The method may include executing the electronic survey, wherein participants of the electronic survey are set to the subset of the human profile data collections. The electronic survey may be a simulated natural language conversation between each persona embodied by each human profile data collection, included in the plurality of human profile data collections. The electronic survey may further include an artificial intelligence (“AI”) large language model (“LLM”)-based conversational assistant.

The method may include storing the simulated natural language conversation in a location within the database. The location may be linked to a storage location of the human profile data collection.

In some embodiments, the method may include augmenting the human profile data collection with a filler human profile data set. The filler human profile data set output from a large language model (“LLM”). The LLM may be in communication with the hardware processor. The filler human profile data set may be output in response to receipt, at the LLM, of a prompt. The prompt may include the human profile data collection, the human profile data and an instruction to output the filler human profile data set that fills in data gaps in the combination of the human profile data that corresponds to the real-time updates and the human profile data collection.

In such embodiments, the method may further include assigning a level of confidence for a response to a first question within the electronic survey based on whether information included in the human profile data collection used to respond to the first question was augmented data from the LLM. When a data element included in the human profile data collection used to respond to the first question was augmented data from the LLM, assigning a lower confidence level than when the information included in the data collection was electronically received or electronically crawled.

A method for generating artificially-intelligent, synthetic responses to a natural language conversational survey may be provided. Methods may create a synthetic persona that reflects an authentic human. Methods may store the synthetic persona as vectors within a vector database. Methods may initiate a survey. Methods may select the synthetic persona from the vector database. The selection is based on a correspondence between data points input by the researcher and vectors included in the synthetic persona. Methods may initiate the survey with the selected synthetic persona as a participant. Methods generate a first question for the survey.

In certain embodiments, methods may augment, at the vector database, the first question with vectors that correspond to data points relevant to the first question. Methods may transmit the augmented first question to a large language model. Methods may receive a response to the augmented first question. Methods may process the response at the survey system.

In some embodiments, methods may generate a prompt. The prompt may include vectors that correspond to data points relevant to the first question. As such, the prompt may include a minimized persona relevant to the first question. The prompt may also include the first question. Methods may include transmitting the prompt to the large language model. Methods may include receiving a response to the prompt from the large language model. Methods may include processing the response at the survey system.

Methods enable the researcher to analyze the survey. The researcher may analyze the survey at a graphical user interface (“GUI”) designed for survey analysis.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

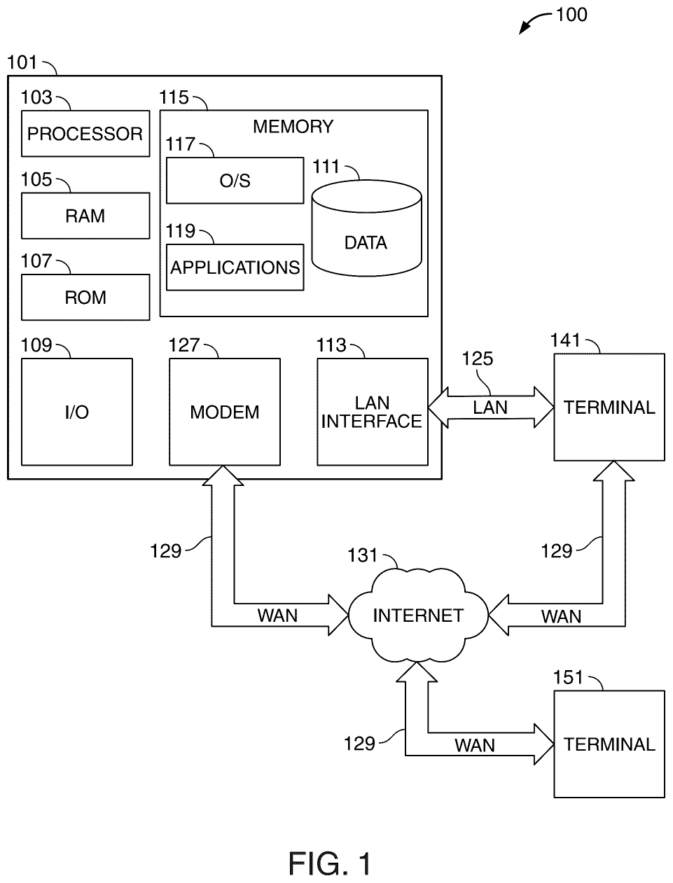

FIG. 1 shows an illustrative block diagram of system 100 that includes computer 101. Computer 101 may alternatively be referred to herein as a “server” or a “computing device.” Computer 101 may be a desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions may be embodied in hardware or firmware (not shown). The computer 101 may execute the instructions embodied by the software to perform various functions.

Input/output (“I/O”) module may include connectivity to a microphone, keyboard, touch screen, mouse, camera, and/or stylus through which a user of computer 101 may provide input. The input may include input relating to cursor movement. The input may be participant input. The participant input may be responsive to a survey, another suitable prompt, or, in some embodiments, self-initiated input. The input may also include input by an administrator via a UI. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, cloud-based memory, or any other suitable memory. Any of various conventional web browsers can be used to display and manipulate retrieved data on web pages.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking user functionality related performing various tasks. The various tasks may be related to assessing and/or maintaining the quality, validity, and/or accuracy of participant input.

Computer 101 and/or terminals 141 and 151 may also be devices including various other components, such as a battery, speaker, and/or antennas (not shown).

Terminal 151 and/or terminal 141 may be portable devices such as a laptop, cell phone, Blackberry™, tablet, smartphone, or any other suitable device for receiving, storing, transmitting and/or displaying relevant information. Terminals 151 and/or terminal 141 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

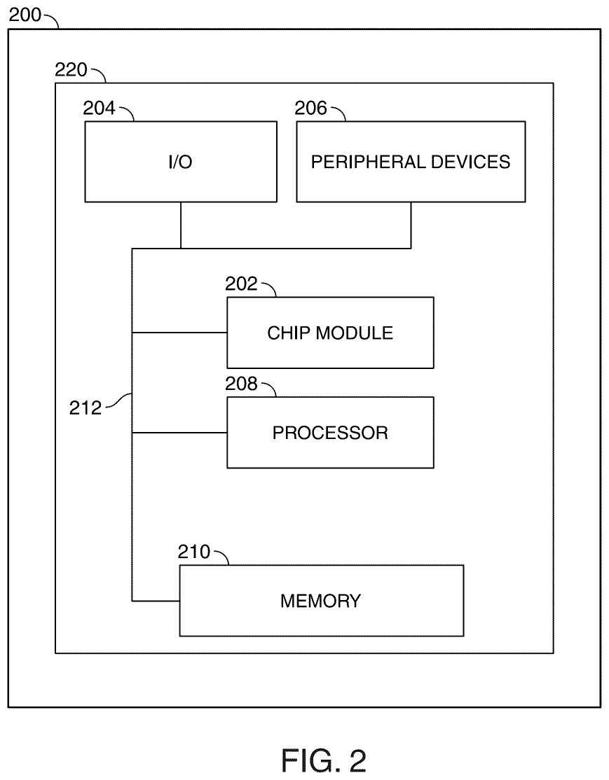

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

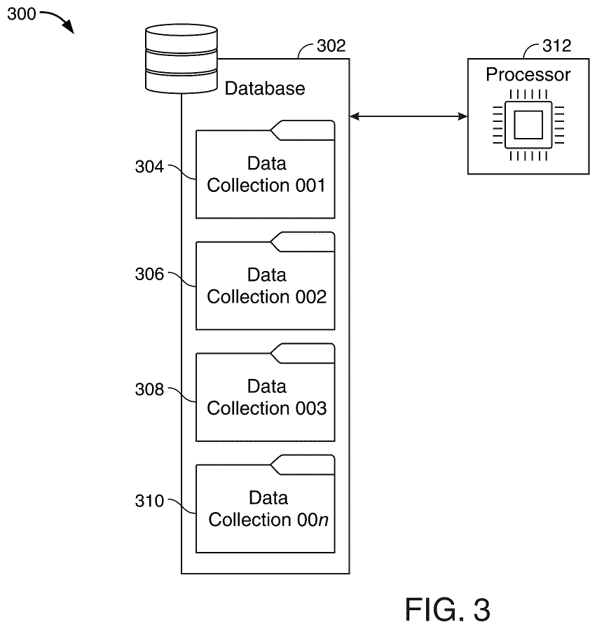

FIG. 3 shows an illustrative diagram 300. Processor 312 may be in electronic communication with database 302. Database 302 may include data collection 001, shown at 304, data collection 002, shown at 306, data collection 003, shown at 308 and data collection n, shown at 310.

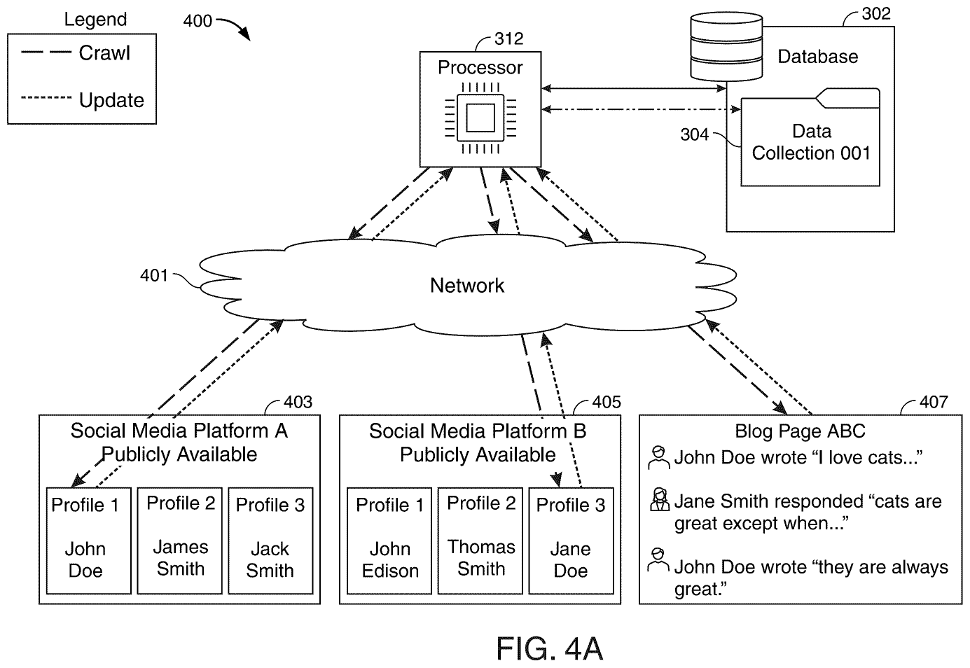

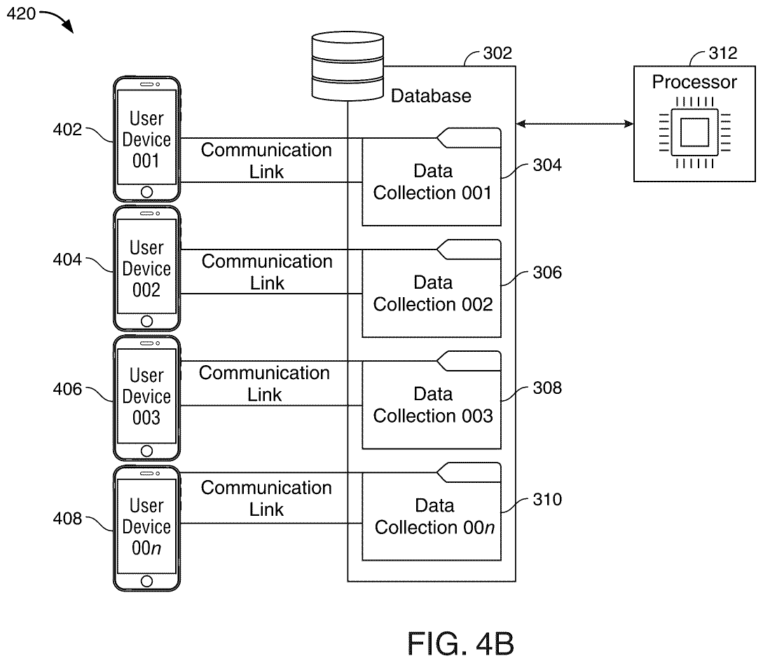

FIG. 4A shows illustrative diagram 400. Illustrative diagram 400 shows processor 312 in communication with database 302. Processor 312 in communication with database 302 may crawl various data sources for data relating to a data collection. Processor 312 may crawl the data sources via a network. As shown in FIG. 4A, processor 312 may crawl, data sources 403, 405 and 407 for data relating to data collection 001. Processor 312 may crawl publicly available data sources, such as social media platform A, shown at 403, and social media platform B, shown at 405, for data relating to a human profile that corresponds to data collection 001. At times, processor 312 may receive permission, from private data source owners, to access the private data sources. The private data source owners may be a human that corresponds to the human profile that corresponds to data collection 001. As such, processor 312 may also crawl the private data source owners to retrieve data that corresponds to a human profile that corresponds to data collection 001. Upon receipt of the data updates, processor 312 may push the data updates to data collection 001 within database 302.

FIG. 4B shows illustrative diagram 420. The electronic communication links shown in FIG. 4B may be continuously updated electronic communication links, continually updated electronic communication links, periodically updated electronic communication links or any other suitable electronic communication links. Data collection 001 may maintain an electronic communication link to user device 001, shown at 402. Data collection 002 may maintain an electronic communication link to user device 002, shown at 404. Data collection 003 may maintain an electronic communication link to user device 003, shown at 406. Data collection n may maintain an electronic communication link to user device n, shown at 408. The electronic communication links may enable user devices 001-n to transmit data to database 302. The electronic communication links may also enable the processor in communication with the database to request data and receive data from user devices 001-n.

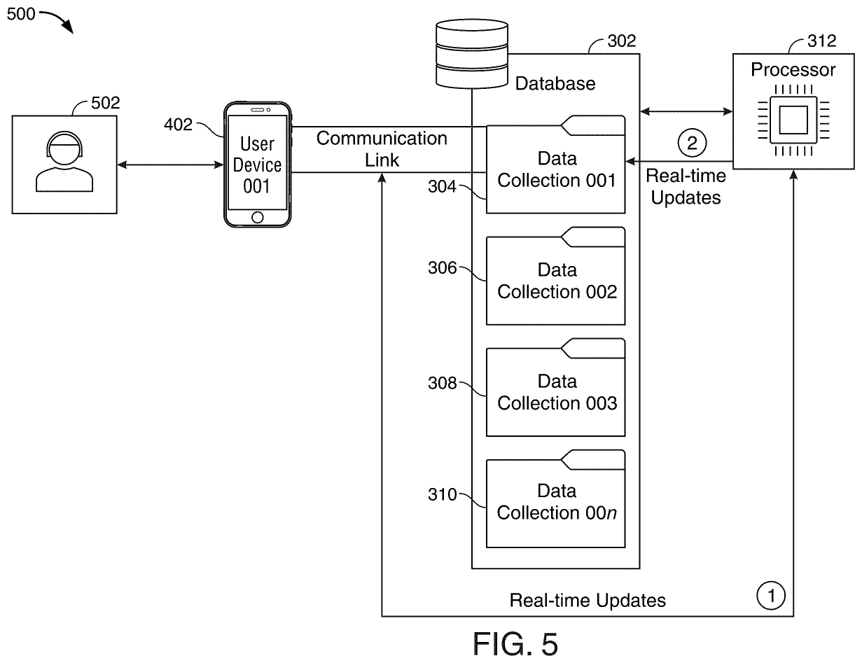

FIG. 5 shows an illustrative diagram 500. Illustrative diagram 500 may show user device 001, shown at 402, maps to authentic human 502. Authentic human may input data into user device 001. The input data may be transmitted to database 302 via the communication link.

Processor 312 may monitor the communication link for data updates, as shown at step 1. Data updates received via the communication link may be input as real-time updates to data collection 001, as shown at step 2.

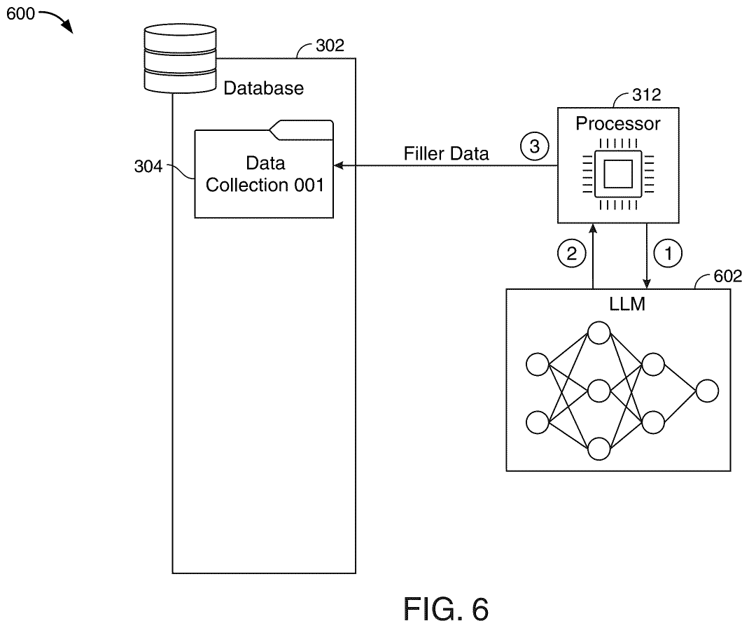

FIG. 6 shows an illustrative diagram 600. Illustrative diagram 600 shows processor 312 communicating with LLM 602. As shown at step 1, processor may request data from LLM 602. The data may be filler data. The filler data may fill in data gaps within data collection 001. It should be noted that, in certain embodiments, the data gaps may be filled-in with statistically reasonable or valid data. The request may include data previously included in data collection 001. The request may be a prompt. The request may include any other suitable data. As shown at step 2, processor 312 may receive the filler data. Upon receipt of the filler data, processor 312 may input the filler data into data collection 001, as shown at step 3.

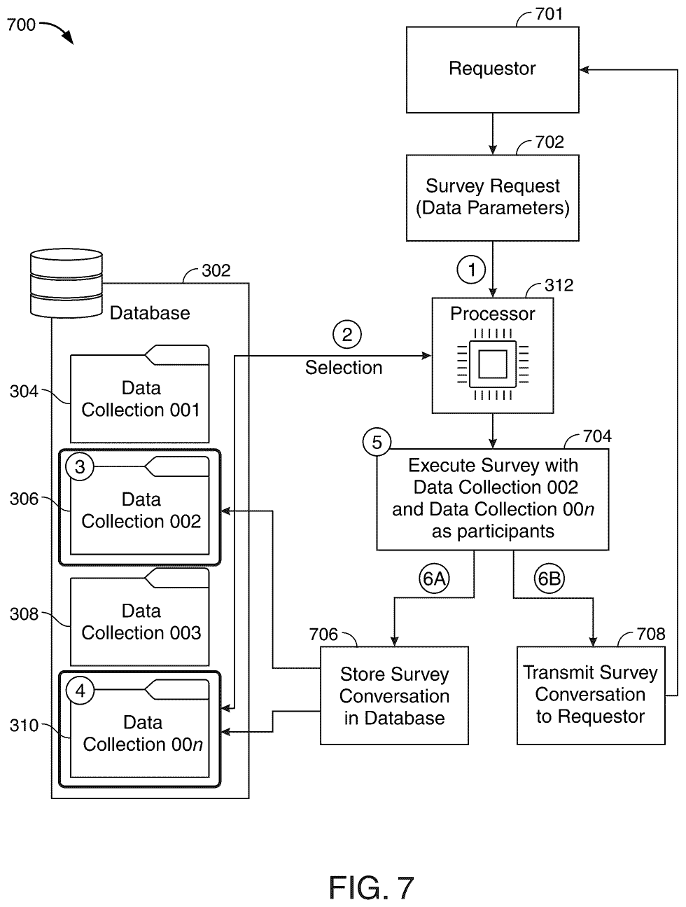

FIG. 7 shows illustrative diagram 700. Requestor 701 may initiate a survey request, as shown at step 702. The survey request may include a plurality of survey parameters. The survey request may be initiated at processor 312, as shown at step 1. The processor may select data collections for participating in the survey, as shown at step 2. The selection may be based on the data included in the data collection and the data parameters. As shown at steps 3 and 4, data collections 2 and n may be selected. Step 5 shows the processor may execute the survey with data collections 2 and n as participants, as shown at 704. Upon completion of the survey, step 6A shows the survey conversation may be stored in the database, as shown at 706. The updates may be real-time updates input to the data collections. Also, upon completion of the survey, step 6B shows the survey conversation may provide survey conversation to requestor, as shown at 708.

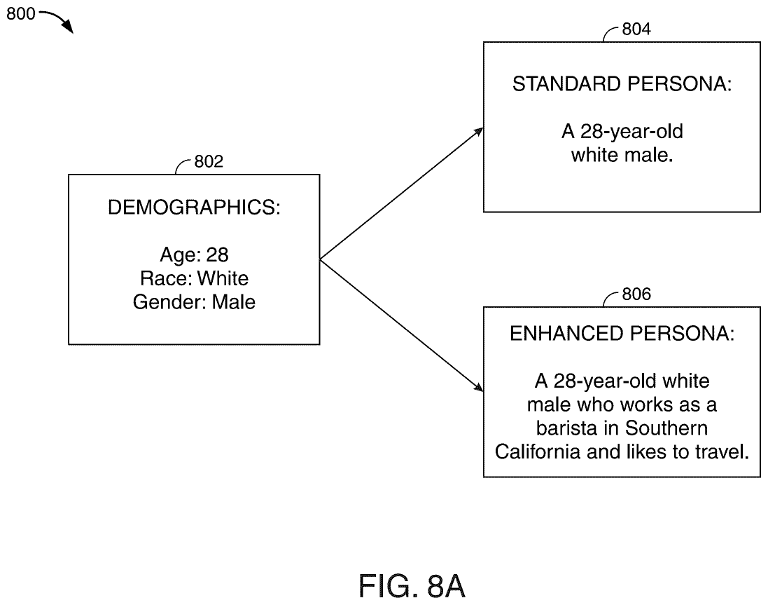

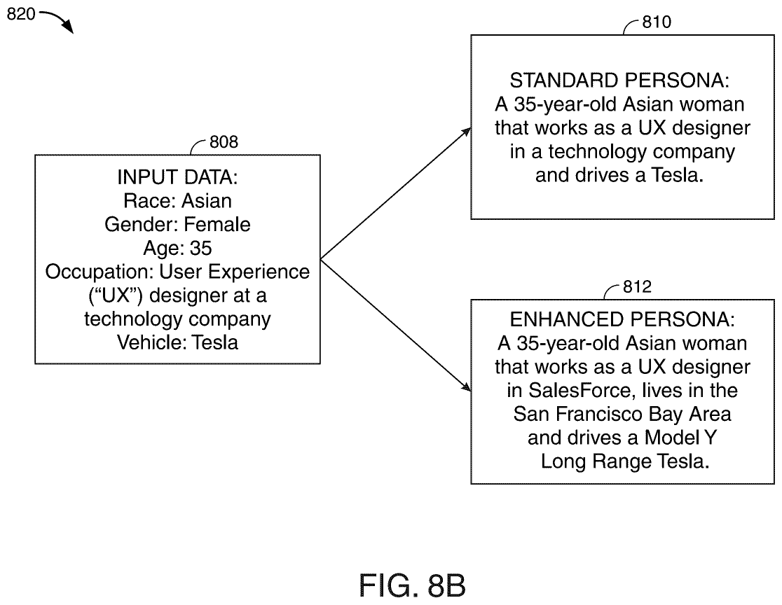

FIG. 8A shows illustrative diagram 800. The illustrative diagram 800 may include input data to be used to generate a persona. The demographic data may include shown at 802. The demographic data may include an age, a race and a gender. The input data may be used to generate a standard persona, shown at 804. The input data may be used to generate an enhanced persona, shown at 806. The standard persona may include the demographic information restructured into a persona. The enhanced persona may include the demographic information restructured into an enhanced persona. The enhanced persona may include additional information that was generated by an LLM.

FIG. 8B shows illustrative diagram 820. The illustrative diagram 820 may include input data to be used to generate a persona. The input data may include shown at 808. The demographic data may include an age, a race and a gender. The input data may be used to generate a standard persona, shown at 810. The input data may be used to generate an enhanced persona, shown at 812. The standard persona may include the input data restructured into a persona. The enhanced persona may include the input data restructured into an enhanced persona. The enhanced persona may include additional information that was generated by an LLM.

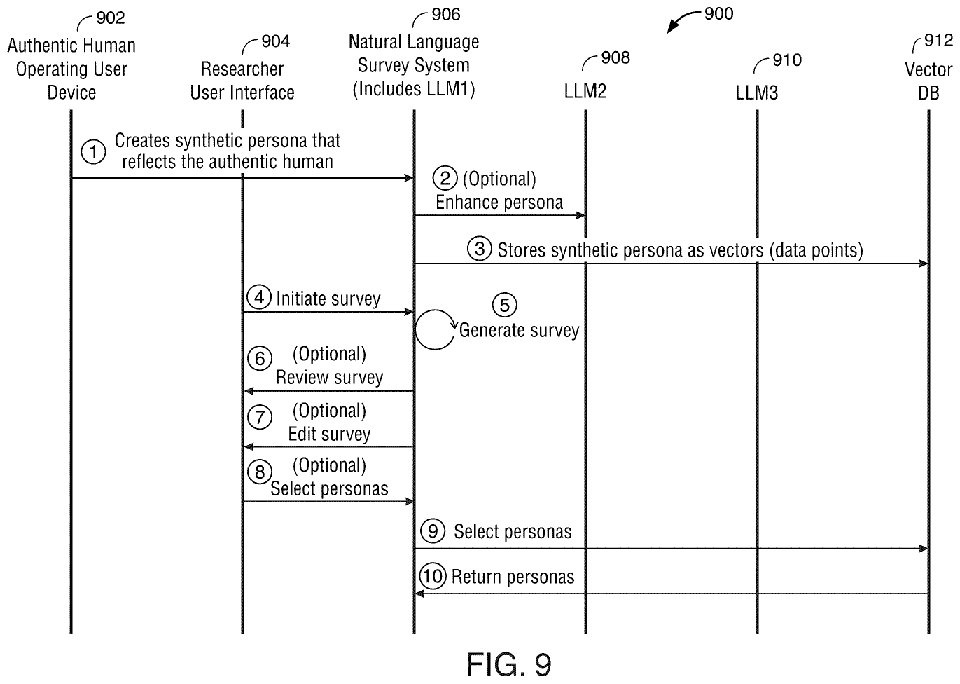

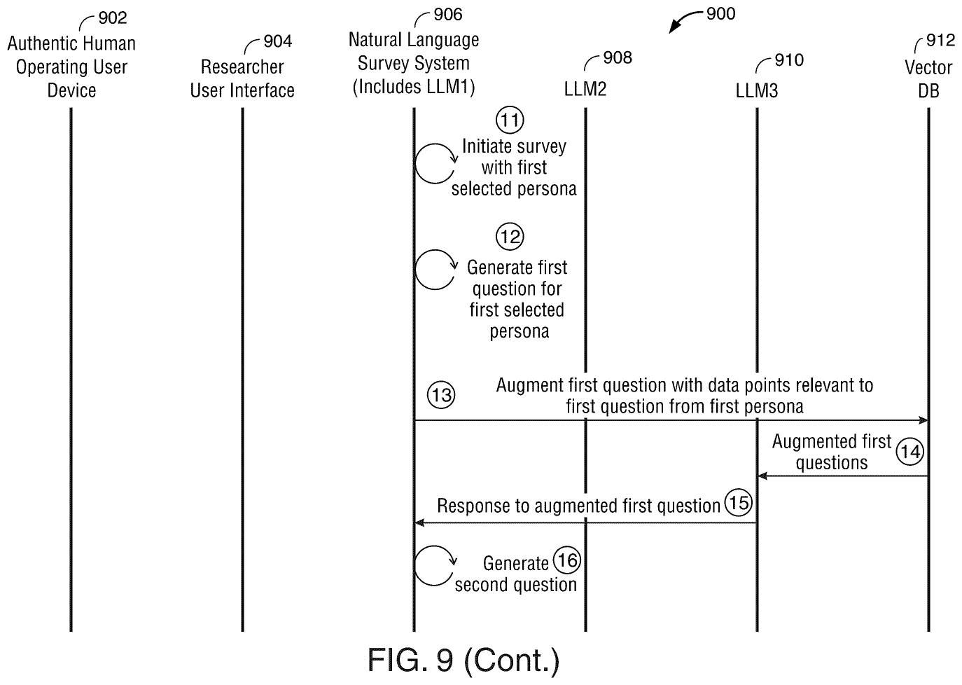

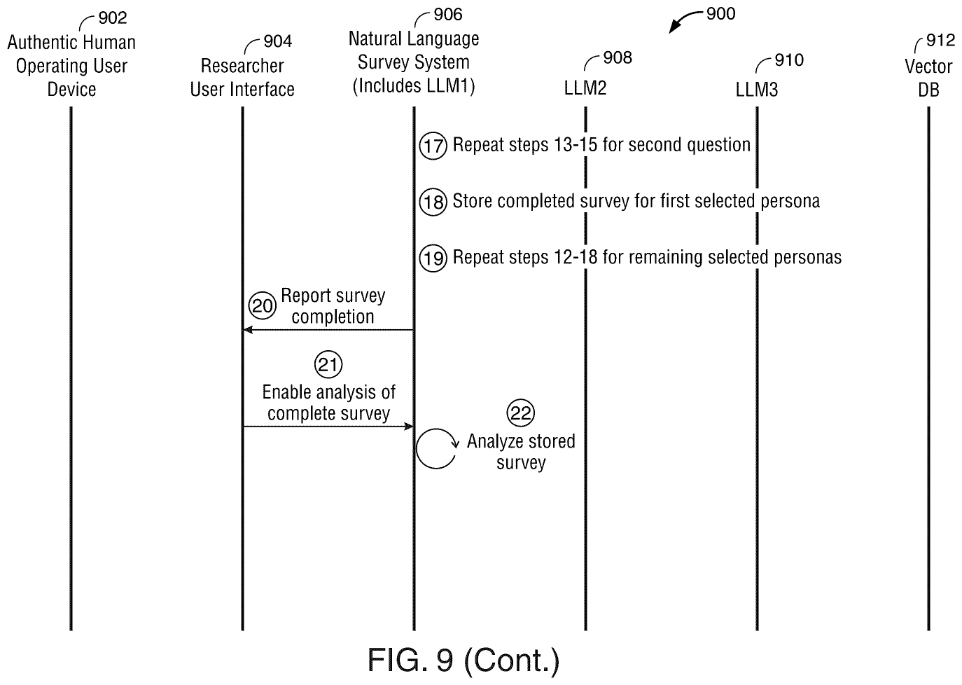

FIG. 9 shows illustrative diagram 900. Illustrative diagram 900 includes communication between an authentic human operating a user device shown at 902, a researcher user interface shown at 904, a natural language survey system (including a first LLM that powers the survey system) shown at 906, a second LLM shown at 908, a third LLM 910 and a vector database 912.

Step 1 shows the authentic human creates a synthetic persona that reflects the authentic human at the survey system. Step 2 shows, optionally, the survey system may instruct the LLM2 to enhance the persona. Step 3 shows the synthetic persona may be stored as vectors/data points in the vector database.

Step 4 shows the researcher, at the researcher UI may initiate the survey. Step 5 shows the survey system may generate the survey. Step 6 shows the survey system may enable the researcher, via the researcher UI, to review the survey. Step 7 shows the survey system may enable the researcher, via the researcher UI, to edit the survey. Step 8 shows the researcher, via the researcher UI, may be enabled to select personas to participate in the survey.

Step 9 shows the survey system selects personas from the vector database. Step 10 shows the selected personas are returned and/or assigned to the survey system.

Step 11 shows the survey system may initiate the survey with a first selected person. Step 12 shows the survey system may generate a first question for the first selected persona. Step13 shows the survey system may augment, or may instruct the vector database to augment, the first question with data point relevant to the first question. The data points may be retrieved from the first persona. Step 14 shows the vector database may transmit the augmented first question to the third LLM. Step 15 shows the response to the augmented first question may be transmitted to the survey system. Step 16 shows the survey system may generate a second question.

Step 17 shows steps 13-15 are repeated for the second question. Step 18 shows the completed survey of the first selected persona is stored at the survey system. Step 19 shows repeat of steps 12-18 for remaining selected personas.

Step 20 shows the survey system may report survey completion to the researcher UI. Step 21 shows may enable the researcher, via the researcher UI, to analyze the completed survey. Step 22 shows researcher, via the researcher UI in communication with survey system, to analyze the stored survey.

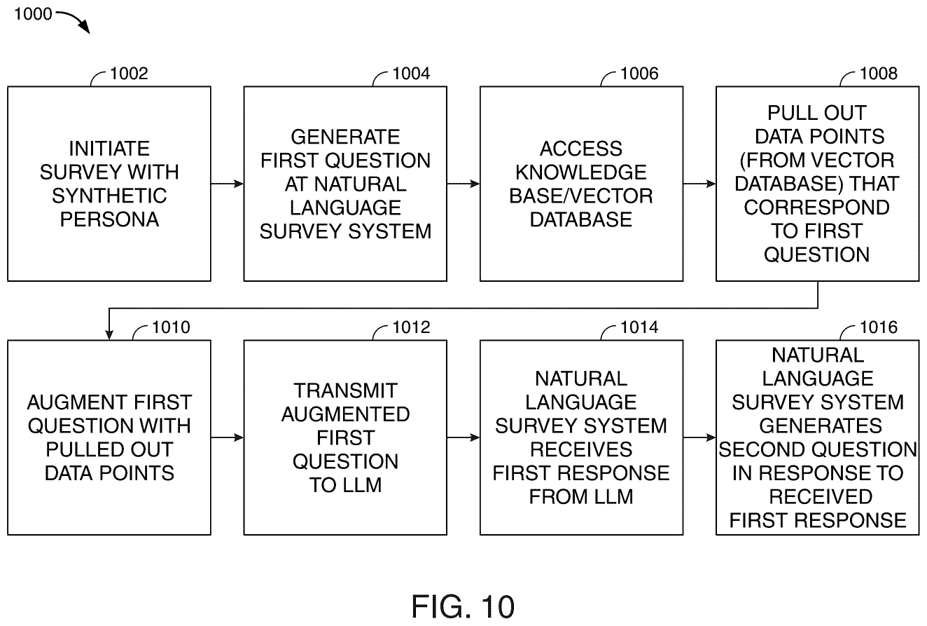

FIG. 10 shows illustrative diagram 1000. Step 1002 shows initiating a survey with a synthetic persona. Step 1002 shows generating a first question at a natural language survey system. Step 1006 shows accessing a knowledge base or vector database. The knowledge base or vector database may store the synthetic personas. Step 1008 shows pulling out data points from the vector database that corresponds to the first question.

Step 1010 shows augmenting first question with pulled-out data points. Step 1012 shows sending augmented first question to an LLM. Step 1014 shows natural language survey system receives first response. The first response may correspond to the first question. Step 1016 shows natural language survey system generates a second question in response to received first response.

The steps of methods of the disclosure may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for artificially-intelligent synthetic data personas based on certified human intelligence are provided. Persons skilled in the art will appreciate that the present invention can be practiced by other than the described embodiments, which are presented for purposes of illustration rather than of limitation, and that the present invention is limited only by the claims that follow.

What is claimed is:

1. A system for generating synthetic responses to survey questions, the system comprising:
a database operable to store a plurality of data collections, each data collection corresponds to a human profile;
a hardware processor, said processor in communication with the database, said hardware processor operable to:
for each data collection:
receive, retrieve, crawl and/or generate real-time updates to the human profile;
store the real-time updates as human profile data in the data collection stored in the database;
augment the data collection with a filler set of human profile data output from a large language model (“LLM”), said LLM in communication with the hardware processor, wherein the data output from the LLM is output in response to receipt, at the LLM, of a prompt, said prompt comprising:
the human profile data; and
an instruction to output the filler set of human profile data that fills in data gaps in the human profile data;
receive a request to initiate an electronic survey, said request comprising a plurality of data boundaries setting forth a class of requested participants of the electronic survey;
iterate through the plurality of data collections to retrieve a subset of data collections that fits within the plurality of data boundaries;
execute the electronic survey, wherein participants of the electronic survey are set to the subset of data collections, the electronic survey being a simulated natural language conversation between a persona embodied by a data collection, included in the subset of data collections, and an artificial intelligence large language model-based conversational assistant; and
store the simulated natural language conversation in a location within the database, the location linked to a storage location of the data collection.

2. The system of claim 1 wherein the human profile comprises:
demographic data; and
responses to questions, said responses to questions comprising:
emotions;
previous responses;
style;
grammar; and
word choice.

3. The system of claim 1 wherein the real-time updates comprises:
demographic data; and
responses to questions, said responses to questions comprising:
emotions;
previous responses;
style;
grammar; and
word choice.

4. The system of claim 1 wherein one or more of the plurality of data collections are temporarily retired upon a predetermined trigger.

5. The system of claim 4 wherein the predetermined trigger comprises:
termination of a communication link between the human profile and a user device, said user device associated with the human profile;
lapse of a predetermined amount of time;
failure to complete, by a user, said user associated with the user device, a predetermined number of questions; and/or
failure to provide, by the user, a predetermined amount of data.

6. The system of claim 4 wherein:
the temporarily retired one or more of the plurality of data collections are stored in a second memory section within the database; and
the hardware processor prevents data collections stored within the second memory section from being included into the subset.

7. The system of claim 6 wherein, upon data input from the user device, the temporarily retired data collection is reinstated as an active data collection.

8. The system of claim 1 wherein each data collection comprises:
a writing style;
a talking style;
a use of a grammar;
a demographics set;
one or more social media profiles;
one or more blog articles;
data relating to how the user device linked to the data collection responded to standard surveys; and
data relating to how the user device linked to the data collection responded to natural language conversational surveys.

9. The system of claim 1 wherein the hardware processor assigns a level of confidence for a response to a first question within the electronic survey based on whether a data element included in the data collection used to respond to the first question was augmented data from the large language model.

10. The system of claim 9 wherein, when the data element included in the data collection used to respond to the first question was augmented from the large language model, the response is assigned a lower confidence score than when the data element is included in the data collection that was input via a communication link.

11. The system of claim 1 wherein the receive, retrieve, crawl and generate is executed periodically.

12. A method for generating artificially-intelligent, synthetic responses to a natural language conversational survey, the method comprising:
electronically receiving, by a hardware processor, a data set corresponding to a human profile;
electronically converting the data set to a human profile data collection;
electronically storing the human profile data collection in a database, said database in electronic communication with the hardware processor;
electronically receiving, by the hardware processor, an electronic request to initiate an electronic survey, the request comprising a plurality of data boundaries setting forth a class of requested participants of the electronic survey;
electronically iterating, by the hardware processor, through a plurality of human profile data collections stored in the database, the plurality of human profile data collections comprising the human profile data collection, and retrieve a subset of human profile data collections that fit within the plurality of data boundaries;
executing the electronic survey, wherein participants of the electronic survey are set to the subset of the human profile data collections, the electronic survey being a simulated natural language conversation between each persona embodied by each human profile data collection, included in the plurality of human profile data collections, and an artificial intelligence large language model (“LLM”)-based conversational assistant; and
electronically storing the simulated natural language conversation in a location within the database, the location linked to a storage location of the human profile data collection.

13. The method of claim 12, wherein prior to electronically converting the human profile data collection, the method comprises electronically augmenting the data set by:
communicating the data set to a large language model;
receiving, from the large language model, filler data; and
inputting the filler data into the human profile data collection.

14. The method of claim 12, wherein the method further comprises augmenting the human profile data collection with a filler human profile data set, said filler human profile data set output from a large language model (“LLM”), said LLM in communication with the hardware processor, the filler human profile data set is output in response to receipt, at the LLM, of a prompt, said prompt comprising:
the human profile data collection;
the human profile data; and
an instruction to output the filler human profile data set that fills in data gaps in the combination of the human profile data that corresponds to the real-time updates and the human profile data collection.

15. The method of claim 12, wherein the data set corresponding to the human profile comprises:
raw demographic data;
raw responses to historical survey questions, said raw responses comprising:
raw emotional data;
raw text response data;
raw style data;
raw grammar data; and
raw word choice data.

16. The method of claim 15, wherein the human profile data collection comprises:
synthetic demographic data generated based on the raw demographic data;
synthetic responses to historical survey questions based on the raw responses to historical survey questions, said synthetic responses comprising:
synthetic emotional data based on the raw emotional data;
synthetic text response data based on the raw text response data;
synthetic style data based on the raw style data;
synthetic grammar data based on the raw grammar data; and
synthetic word choice data based on the raw word choice data.

17. The method of claim 12 wherein one or more of the plurality of human profile data collections are temporarily retired upon detection of a predetermined trigger.

18. The method of claim 17 wherein the predetermined trigger comprises:
termination of a communication link between the human profile data collection and a user device;
lapse of a predetermined amount of time from instantiation of the human profile data collection;
failure to electronically complete, by a user associated with the human profile data collection, a predetermined number of questions; and/or
failure to electronically transmit, by the user, a predetermined amount of data.

19. The method of claim 17, further comprising:
electronically labeling, within the database, the one or more temporarily retired human profile data collections inactive; and
electronically preventing the one or more human profile data collections labeled inactive from being included into the subset.

20. The method of claim 19 further comprising:
receiving data input from a user device associated with a temporarily retired human profile data collection included in the one or more temporarily retired human profile data collections;
electronically labeling the temporarily retired human profile data collection as active; and
re-enabling the active human profile data collection from being included in the subset.

21. The method of claim 12 wherein the human profile data collection comprises:
a writing style;
a talking style;
a use of a grammar set;
a demographic set;
one or more social media profiles;
one or more blog articles;
a data set relating to how a user device linked to the human profile data collection responded to standard surveys; and/or
a data set relating to how a user device linked to the data collection responded to natural language conversational surveys.

22. The method of claim 13 further comprising assigning a level of confidence for a response to a first question within the electronic survey based on whether a data element included in the human profile data collection used to respond to the first question was augmented data from the LLM.

23. The method of claim 22 wherein, when the data element included in the human profile data collection used to respond to the first question was augmented data from the LLM, assigning a lower confidence level than when information included in the data collection was electronically received or electronically crawled.

24. The method of claim 14 further comprising assigning a level of confidence for a response to a first question within the electronic survey based on whether information included in the human profile data collection used to respond to the first question was augmented data from the LLM.

25. The method of claim 24 wherein, when a data element included in the human profile data collection used to respond to the first question was augmented data from the LLM, assigning a lower confidence level than when the information included in the data collection was electronically received or electronically crawled.

26. The method of claim 12 wherein the electronically crawled is executed periodically.

27. The method of claim 12 further comprising:
electronically crawling, by the hardware processor, a network for real-time updates to the human profile data collection stored in the database;
electronically retrieving, by the hardware processor, the real-time updates; and
electronically storing, by the hardware processor, the real-time updates as human profile data in the human profile data collection stored in the database.

28. A method for generating artificially-intelligent, synthetic responses to a natural language conversational survey, the method comprising:
creating, at a natural language survey system, a synthetic persona that reflects an authentic human;
storing the synthetic persona as vectors within a vector database;
initiating a natural language survey at a researcher user interface in communication with the survey system;
selecting, from the vector database, the synthetic persona, the selecting based on a correspondence between data points input by the researcher and vectors included in the synthetic persona;
initiating, at the natural language survey system, the survey with the selected synthetic persona as a participant;
generating, at the natural language survey system, a first question for the survey;
augmenting, at the vector database, the first question with vectors that correspond to data points relevant to the first question, said data points included in the synthetic persona;
transmitting the augmented first question to a large language model;
receiving a response, at survey system, to the augmented first question;
processing the response at the survey system; and
enabling the researcher, via the researcher user interface, to analyze the survey, said survey comprising the first question, the augmented first question and the response.

29. A method for generating artificially-intelligent, synthetic responses to a natural language conversational survey, the method comprising:
creating, at natural language survey system, a synthetic persona that reflects an authentic human;
storing the synthetic persona as vectors within a vector database;
initiating a natural language survey at a researcher user interface in communication with the survey system;
selecting, from the vector database, the synthetic persona, the selecting based on a correspondence between data points input by the researcher and vectors included in the synthetic persona;
initiating, at the natural language survey system, the survey with the selected synthetic persona as a participant;
generating, at the natural language survey system, a first question for the survey;
retrieving, from the vector database, vectors that correspond to data points relevant to the first question, said data points included in the synthetic persona;
transmitting, to a large language model, a prompt, the prompt comprising the first question and the vectors that correspond to data points relevant to the first question;
receiving a response, at survey system, to the prompt;
processing the response at the survey system; and
enabling the researcher, via the researcher user interface, to analyze the survey, said survey comprising the first question and the response.

30. The method of claim 29 wherein the survey further comprises the synthetic persona.
